(19) United States
(12) Patent Application Publication
(10) Pub. No.: US 2005/0216276 A1
(43) Pub. Date: Sep. 29, 2005

(54) Method and system for voice-inputting chinese character

(76) Inventors: Ching-Ho Tsai, Huatan Township (TW); Yun-Wen Lee, Taipei City (TW); Jui-Chang Wang, Taipei City (TW)

Correspondence Address: J C PATENTS, INC., 4 VENTURE, SUITE 250, IRVINE, CA, 92618, US

(21) Appl. No.: 10/859,782

(22) Filed: Jun. 3, 2004

(30) Foreign Application Priority Data
Mar. 23, 2004 (TW) 93107735

(51) Int. Cl. G10L 11/00

(52) U.S. Cl. 704/277

(57) ABSTRACT

A method of voice-inputting a Chinese character is provided. The method comprises: inputting a target character in a voice; generating a plurality of candidate characters including the target character based on a spelling of the target character; and selecting the target character from the plurality of candidate characters based on a description of the target character. Because the method combines the CSL and CDL mechanisms so that it can generates the accurate character.

### CROSS-REFERENCE TO RELATED APPLICATION

This application claims the priority benefit of Taiwan application serial no. 93107735, filed on Mar. 23, 2004, the full disclosure of which is incorporated herein by reference.

### BACKGROUND OF THE INVENTION

1. Field of the Invention

This invention generally relates to a voice-inputting method, and more particularly to a method and a system for voice-inputting Chinese character by combining the character spelling language (CSL) and the character description language (CDL).

2. Description of Related Art

As the modern technology and the computer-related technology advances, the communication between the computer and people are more and more important. The traditional communication device between the computer and people is, for example, a keyboard to input the command and the computer outputs the information via the screen or printer. Conventionally, while inputting Chinese character into the computer, the users have to be familiar with the rules for inputting the Chinese characters such as the existing Chinese character input methods. Without learning how to use those Chinese input methods, one cannot effectively input the Chinese characters into the computer. Therefore, the other Chinese character input methods such as handwriting input method or voice input method have been developed.

FIG. 1 is the block diagram of the traditional voice recognizing system. Referring to FIG. 1, the traditional voice recognizing system 110 includes the voice recognizer 112 and the database 114. When the user inputs the voice 101 into the traditional voice recognizing system 110, the voice recognizer 112 will capture the candidate set 116 from the database 114 based on the voice input 101 and display the candidate set 116 on the screen 103. The user then selects the desired one from the candidate set 116 on the screen 103. The drawback of the traditional voice recognizing system 110 is that it requires a screen 103 to display the candidate set 116 for the user's selection. For the input system without output display such as telephone system, the traditional voice recognizing system 110 is difficult for input Chinese character.

The database disclosed in U.S. Pat. No. 6,163,767 (Inventors: Donald T. Tang et al.) is also impractical because there are too many variations of the Chinese characters. It is impossible to store all the variations of the Chinese characters in the database. Even if all variations of the Chinese characters were stored in the database, the huge database would not be suitable for the personal computers. In addition, this patent also fail to consider the system's error determination if the user speaks with a lisp. For example, the user may pronounce z- [symbol] as zh- [symbol] or -ng [symbol] as -

[symbol]

### SUMMARY OF THE INVENTION

The present invention is directed to a method and a system for inputting Chinese characters to output the accurate Chinese character without the screen for selection to output the target character.

The present invention is directed to a method and a system for inputting Chinese characters to output the accurate Chinese character even when the user speaks with a lisp.

According to an embodiment of the present invention, the method of voice-inputting a Chinese character comprises, first, a target character input via a voice. Next, a plurality of candidate characters including the target character based on a spelling of the target character is generated. Thereafter, the target character from the plurality of candidate characters is selected based on a description of the target character.

In an embodiment of the present invention, the step of generating the plurality of candidate characters further includes generating the plurality of candidate characters based on a syllable of the target character inputted by a user. Therefore, it is possible to significantly enhance the character accuracy of determining the voice input by the user. In addition, the present invention allows the user to use ZhuYin and PinYin methods to spell the target character.

Further, the present invention provides the following methods for the system to describe the target character:
A. Structure method—Describing the target character based on the structure of the target character;
B. Phrase method—Describing the target character with the phrase, name, and idiom which containing the target character.
C. Radical method—Describing the target character based on the radical of the target character.

According to an embodiment of the present invention, the system for voice-inputting a Chinese character comprises a database, a character spelling language analyzer, and a character description language generator. Wherein, the character spelling language analyzer is adapted for capturing a candidate character set stored in the database to the character description language generator based on a voice-inputted of a target character which is inputted by a user. The character description language generator is adapted for selecting the target character from the candidate character set based on a selection of the user.

In an embodiment of the present invention, the character spelling language analyzer allows the user use one of a ZhuYin method or a PinYin method. In order to promote the accuracy, the character spelling analyzer in addition to consideration of spelling of the target character inputted by the user, the candidate character set is further generated based on a syllable of the target character inputted by the user.

In an embodiment of the present invention, the character description language generator generates the verbalism having the identifiable description based on a description of one of a structure and a radical of the target character, or based on one of a phrase, a name, and an idiom having the target character for the user to select the target character from the candidate characters.

In light of the above, according to an embodiment of the present invention, the CSL and CDL mechanisms are combined to generate the accurate character without the selection via screen to output the target character. In addition, the candidate character set is generated after the users voice-inputs the target character so that an accurate Chinese character is generated even when the user speaks with a lisp.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 is a block diagram of a traditional voice recognizing system.

FIG. 2 is a block diagram of a Chinese character voice-input system in accordance with an embodiment of the present invention.

FIG. 3 is a flow chart of a Chinese character voice-input system in accordance with an embodiment of the present invention.

FIG. 4 shows an operation of the CDL generator in accordance with an embodiment of the present invention.

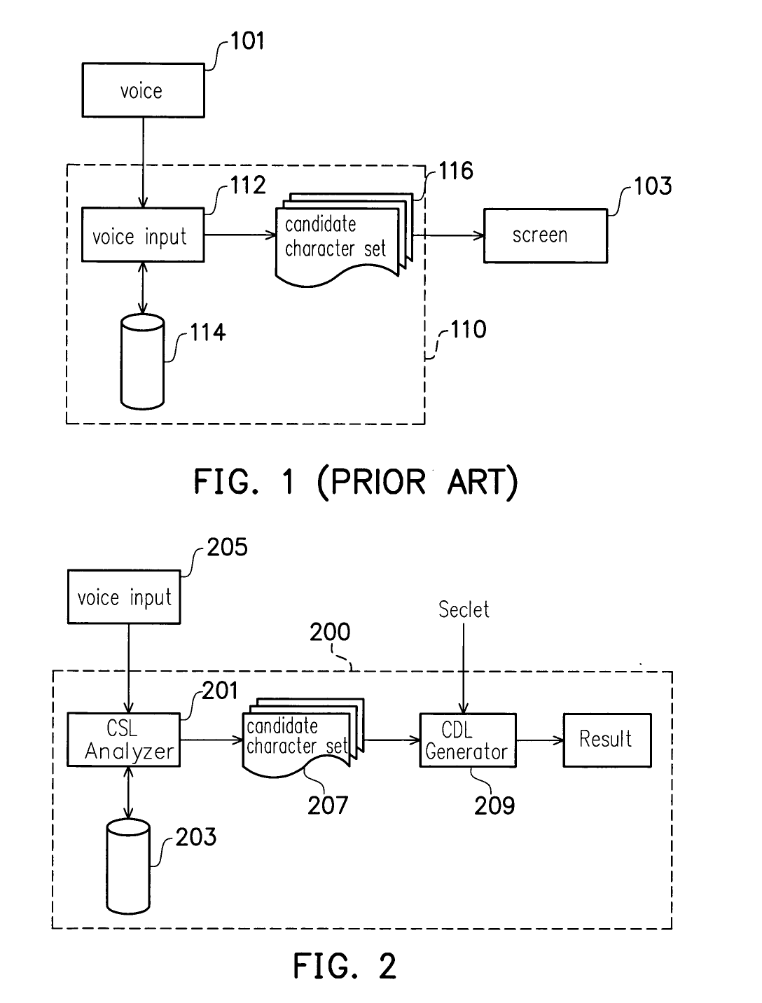

### DESCRIPTION OF THE EMBODIMENTS

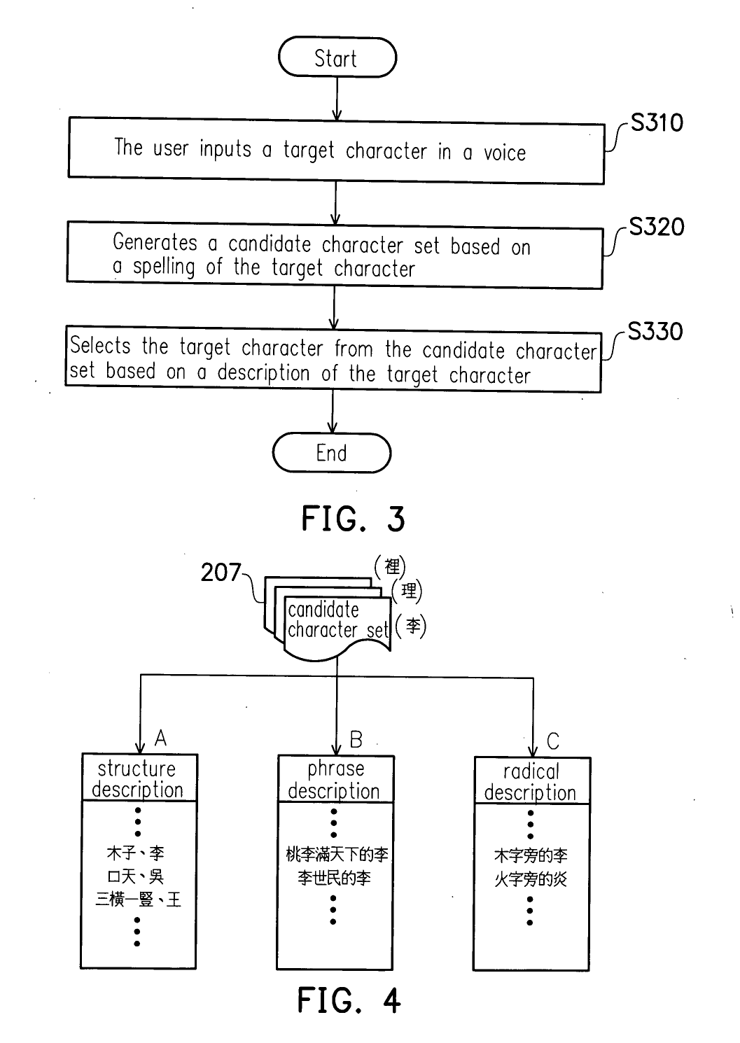

FIG. 2 is a block diagram of a Chinese character voice-input system in accordance with an embodiment of the present invention. FIG. 3 is a flow chart of a Chinese character voice-input system in accordance with an embodiment of the present invention. Referring to FIGS. 2 and 3, when the user inputs a target character to the voice-input system 200 (S310) using a voice, the character spelling language analyzer (CSL analyzer) 201 generates a candidate character set 207 from the database 203 based on a spelling of the target character inputted by the user (S320), and sends the candidate character set 207 to the character description language generator (CDL generator) 209.

In another embodiment, CSL analyzer 201, in addition to considering the spelling of the target character inputted by the user, generates the candidate character set 207 further based on a syllable of the target character inputted by the user. Then the CDL generator 209 generates a verbalism having an identifiable description for each candidate character in the candidate character set (S330) and then the user selects the target character from the candidate character set 207.

Referring to FIG. 2, this embodiment provides two CSL methods so that the CSL analyzer 201 can determine the target character based on the voice input 205. These two CSL phraseologies will be described as follows:

A. ZhuYin phraseology: The user uses the syllable of the target character and the ZhuYin method as the voice input 205. For example, if the user is going to input the target character [symbol] to the voice input system 200, the content of the voice input is [symbol] (te) [symbol] (ai) [symbol] or [symbol] (ai)

[symbol]

B. PinYin phraseology: The user uses the syllable of the target character and the PinYin method as the voice input 205. For example, if the user is going to input the target character [symbol] to the voice input system 200, the content of the voice input is [symbol] T`A`I` [symbol] or [symbol] T`A`I` [symbol] In addition, in the PinYin phraseology method, the PinYin method can be the HanYu PinYin, TungYong PinYin or other PinYin methods.

In the above two CSL phraseologies, the system will compare the syllable and the spelling of the target character. Further, the syllable of each target character will be repeated twice when it is inputted so that the number of the sample will increase for comparison. Hence, it becomes more precise when the CSL analyzer 201 generates the candidate character set 207.

In addition, when the CSL analyzer 201 captures the candidate character set 207, it will capture some characters having the similar spelling. For example, when the user is going to input the target character [symbol] (chao3)”, the CSL analyzer 201 will capture the characters having the similar spelling such as [symbol] (chao1)” (different stress) and [symbol] (cao3)” (the difference between “ch” and “c”) into the candidate character set 207 in order to prevent the user's lisp from the incorrect determination of the voice input system 200.

FIG. 4 shows the operation of the CDL generator in accordance with an embodiment of the present invention. In FIG. 2, after the candidate character set 207 is sent to the CDL generator 209, the CDL generator 209 operates as shown in FIG. 4. Referring to FIG. 4, when the CDL generator 207 receives the candidate character set 207, it will generate a verbalism having an identifiable description for each candidate character in the candidate character set based on a CDL phraseology. This embodiment provides three CDL phraseologies for the system to describe the target character.

A. Structure description: The system can use the structure of the target character to describe the target character such as [symbol] or [symbol] Hence, when the system describes the target character [symbol] it can use the structure of the target character such as [symbol] to describe the target character

[symbol]

B. Phrase description: The system can use the phrase, name, or idiom having the target character to describe the target character. For example, when the system describes the target character [symbol] it can use [symbol] [symbol] or [symbol] [symbol] to describe the target character

[symbol]

C. Radical description: The system can use the radical of the target character to describe the target character such as [symbol] or [symbol] Hence, when the system describes the target character [symbol] it can use the radical of the target character [symbol] to describe the target character

[symbol]

In light of the above, the present invention has the following advantages:

1. Accurate character via voice input.

2. Because the CSL analyzer and the CDL generator are adapted to compare the voice input of the target character, the screen is not required for selection to output the correct target character.

3. Because the characters having the similar spelling when generating the candidate character set are captured, the fault tolerance is enhanced.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method of voice-inputting a Chinese character, comprising:
inputting a target character using a voice;
generating a plurality of candidate characters including said target character based on a spelling of said target character; and
selecting said target character from said plurality of candidate characters based on a description of said target character.

2. The method of claim 1, wherein said step of generating said plurality of candidate characters further includes generating said plurality of candidate characters based on a syllable of said target character inputted by a user.

3. The method of claim 1, wherein said spelling of said target character includes a ZhuYin method and a PinYin method.

4. The method of claim 1, wherein said description of said target character includes a structure method, said structure method describing said target character based on a structure of said target character.

5. The method of claim 4, wherein said description of said target character includes a radical method, said radical method describing said target character based on a radical of said target character.

6. The method of claim 1, wherein said description of said target character includes a phrase method, said phrase method describing said target character based on one of a phrase, a name, and an idiom having said target character.

7. The method of claim 6, wherein said description of said target character includes a combination of any of said structure method, said phrase method, and said radical method.

8. The method of claim 1, wherein said description of said target character includes a radical method, said radical method describing said target character based on a radical of said target character.

9. The method of claims 8, wherein said description of said target character includes a combination of any of said structure method, said phrase method, and said radical method.

10. A system for voice-inputting a Chinese character, comprising:
a database, for storing a plurality of Chinese characters of said system;
a character spelling language analyzer, for generating a candidate character set from said database based on a spelling of said target character inputted by a user; and
a character description language generator, for generating a verbalism having an identifiable description for each candidate character in said candidate character set for said user to select said target character from said candidate characters.

11. The system of claim 10, wherein said user uses one of a ZhuYin method and a PinYin method to obtain a spelling of said target character in order for said character spelling language analyzer to generate said candidate character set.

12. The system of claim 10, wherein said character spelling language analyzer generates said candidate character set further based on a syllable of said target character inputted by said user.

13. The system of claim 10, wherein said character description language generator generates said verbalism having said identifiable description based on a description of one of a structure and a radical of said target character for said user to select said target character from said candidate characters.

14. The system of claim 10, wherein said character description language generator generates said verbalism having said identifiable description based on one of a phrase, a name, and an idiom having said target character for said user to select said target character from said candidate characters.
